(19) United States
(12) Patent Application Publication
(10) Pub. No.: US 2010/0308667 A1
(43) Pub. Date: Dec. 9, 2010

(54) ARRANGEMENT OF POWER SUPPLY CELLS WITHIN CELL-BASE INTEGRATED CIRCUIT

(75) Inventor: Taro Sakurabayashi, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki (JP)

(21) Appl. No.: 12/789,727

(22) Filed: May 28, 2010

(30) Foreign Application Priority Data
Jun. 8, 2009 (JP) 2009-137210

(51) Int. Cl. H02B 1/20

(52) U.S. Cl. 307/147

(57) ABSTRACT

A semiconductor device is provided with a first power supply cell, first cells and second cells. The first power supply cell and the first cells are continuously arrayed in a row direction in a first row. The second cells are continuously arrayed in the row direction in a second row adjacent to the first row. The first power supply cell is connected to a first power supply line extending perpendicularly to the row direction to feed a power supply voltage corresponding to a voltage fed from the first power supply line to the plurality of first and second cells. One of the second cells is indirectly connected to the first power supply line through the first power supply cell, the one of the second cells being positioned adjacent to the first power supply cell.

### INCORPORATION BY REFERENCE

This application claims the benefit of priority based on Japanese Patent Application No. 2009-137210, filed on Jun. 8, 2009, the disclosure of which is incorporated herein by reference.

### BACKGROUND OF THE INVENTION

1. Field of the Invention

The present invention generally relates to a semiconductor device, and more particularly to a semiconductor device having power supply cells supplying a power supply voltage to cells arranged in the same row.

2. Description of the Related Art

As shown in FIG. 1, a semiconductor device is often provided with power supply cells, denoted by numeral 70 in FIG. 1, for supplying a power supply voltage to a plurality of cells, denoted by numeral 10, arranged in the same row. In order to ensure a power supply voltage required for operations of the cells 10, the cells 70 are arranged at predetermined intervals (with distances B1 and B2 in FIG. 1) in the same row.

In the following, a description is given of the layout of the conventional semiconductor device shown in FIG. 1. Referring to FIG. 1, the conventional semiconductor device includes: power supply lines 41 to 43 extending in the row direction (in the X axis direction); ground lines 51 and 52 extending in the row direction; a plurality of cells 10 (e.g., primitive cells or standard cells) disposed along the power supply lines 41 to 43, and the ground lines 51 and 52; power supply lines 61 to 63 extending in a vertical direction (in the Y axis direction) perpendicular to the power supply lines 41 to 43; and a plurality of cells 70 arranged along the power supply lines 61 to 63, respectively.

The power supply cells 70 are disposed at predetermined intervals (with the distance B1) in the same row and provided with power supply elements 80 supplying the power supply voltage to the cells 10 disposed in the same row. Usually, the cells 70 are disposed in the vicinity of the power supply lines 61-63, respectively. Each of the power supply elements 80 has a well contact to supply a power supply voltage VDD from the power supply lines 61 to 63 to the substrate (or the N well 1) of each cell 10 in the same row, for example. Alternatively, the power supply elements 80 may have power supply switches supplying a power supply voltage VSD corresponding to the power supply voltage VDD from the power supply lines 61 to 63, to the cells 10 via the power supply lines 41 to 43. The power supply switches control the supply of the power supply voltage VSD to the cells 10 in accordance with a control signal (not shown).

The power supply voltage VSD is supplied to the power supply lines 41 to 43, and the ground lines 51 and 52 are connected to ground GND. The plurality of cells 10 are respectively provided with contacts, and the power supply voltage VSD is supplied to the cells 10 from the closest one of the power supply lines 41 to 43 via the contacts, respectively. Further, the plurality of cells 10 and 70 are grounded via the closest one of the ground lines 51 and 52. It should be noted that each power supply element 80 may include both of a well contact and a power supply switch.

The cells 10 each include logical circuits operated on the power supply voltage VSD and the ground voltage GND supplied from the power supply lines 41 to 43 and the ground lines 51 and 52, respectively.

Each of the cells 10 and cells 70 incorporates an N well 1 and P well 2. An N well 1 in a specific cell 10 is connected to the N well 1 in the cell 10 or the cell 70 adjacent to the specific cell 10 in the same row. Similarly, a P well 2 in a specific cell 10 is connected to the P well 2 in the cell 10 or cell 70 adjacent to the specific cell 10 in the same row. Thus, the N wells 1 and the P wells 2 are continuously formed in the same row.

Such a semiconductor device is disclosed in, for example, Japanese Patent Application Publication No. P2008-103569A.

The interval (or the distance B1) between the adjacent two cells 70 in the same row depends on the distance between the associated two power supply elements 80, which is defined in accordance with the generation of the manufacture process of the semiconductor device. For example, in a case where the power supply elements 80 are well contacts supplying the power supply voltage VDD to the N wells 1, the distances C1 and C2 between the adjacent power supply elements 80 are defined based on an latch-up standard defined in accordance with the manufacture process.

The region in which the cells 10 can be disposed depends on the distances B1 and B2 between the adjacent cells 70 in the same row. Since the distances B1 and B2 are restricted by the manufacture process as mentioned above, the number and size of the cells 10 which can be placed are also restricted by the manufacture process.

On the other hand, there arises a demand for increasing the number of cells 10 for higher integration of the semiconductor device without increasing the chip area. Therefore, it is requested to increase the number of the cells 10 disposed between the power supply cells (cells 70) while the restrictions imposed by manufacture process are satisfied. Further, there may be a case that large-sized cells 10 cannot be successfully disposed, when the region in which the cells can be disposed in the same row is narrow. Accordingly, there is a need for enlarging the area in which the cells can be disposed in the same row, to thereby increase the flexibility of the size of the cells 10 to be disposed.

### SUMMARY

In an aspect of the present invention, a semiconductor device is provided with a first power supply cell, first cells and second cells. The first power supply cell and the first cells are continuously arrayed in a row direction in a first row. The second cells are continuously arrayed in the row direction in a second row adjacent to the first row. The first power supply cell is connected to a first power supply line extending perpendicularly to the row direction to feed a power supply voltage corresponding to a voltage fed from the first power supply line to the plurality of first and second cells. One of the second cells is indirectly connected to the first power supply line through the first power supply cell, the one of the second cells being positioned adjacent to the first power supply cell.

The present invention effectively improves flexibility of the layout of a semiconductor device.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a plan view showing the layout of a conventional semiconductor device;

FIG. 2 is a plan view showing an exemplary layout of a semiconductor device in a first embodiment of the present invention;

FIG. 3 is a plan view showing a first example of the layout of a semiconductor device of the first embodiment of the present invention;

FIG. 4 is a plan view showing a second example of the layout of the semiconductor device of the first embodiment of the present invention;

FIG. 5 is a plan view showing a third example of the layout of the semiconductor device of the first embodiment of the present invention;

FIG. 6 is a plan view showing a fourth example of the layout of the semiconductor device of the first embodiment of the present invention;

FIG. 7 is a plan view showing a comparative example for the first example of the semiconductor device a of the first embodiment of the present invention;

FIG. 8 is a plan view showing a comparative example for the second example of the semiconductor device of the first embodiment of the present invention;

FIG. 9 is a plan view showing a comparative example for the third example of the semiconductor device of the first embodiment of the present invention;

FIG. 10 is a plan view showing an exemplary layout of a semiconductor device in a second embodiment of the present invention; and

FIG. 11 is a plan view showing an example of the layout of the semiconductor device of the second embodiment of the present invention.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Embodiments of a semiconductor device and a layout method thereof according to the present invention will be described below referring to the accompanying drawings.

### Overview of Embodiments

An arrangement in which well contacts (or N-type diffusion layers) are positioned near power supply switching elements effectively improves interconnection routing efficiency. Therefore, power supply cells (cells 70) incorporating well contacts and power supply switches are conventionally positioned with intervals required for avoiding latch-up. Such arrangement, however, is not suitable for using large-sized standard cells, since the size of the power supply cells 70 is large; the cell width of the power supply cells is twice of that of primitive cells.

To address this issue, the present invention effectively reduces the number of the power supply cells arranged in each row by feeding the power supply voltage to a well commonly shared by adjacent two rows through one well contact; this technical idea is based on the fact that each well are shared by two rows at the boundary thereof. The distance between the adjacent two power supply cells in the present invention is increased approximately twice of that of the conventional well contact arrangement, by disposing cells having well contacts and power supply switches (power supply cells: cells 20) in a staggered arrangement over two rows. This arrangement effectively improves the layout flexibility in a case when large-sized standard cells are used.

### 1. First Embodiment

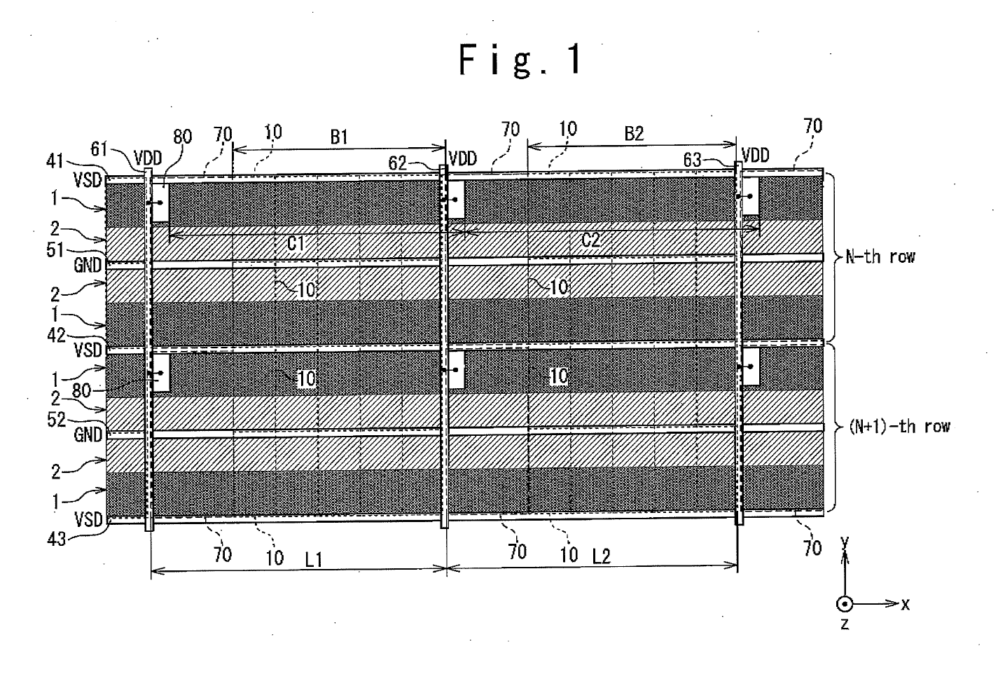

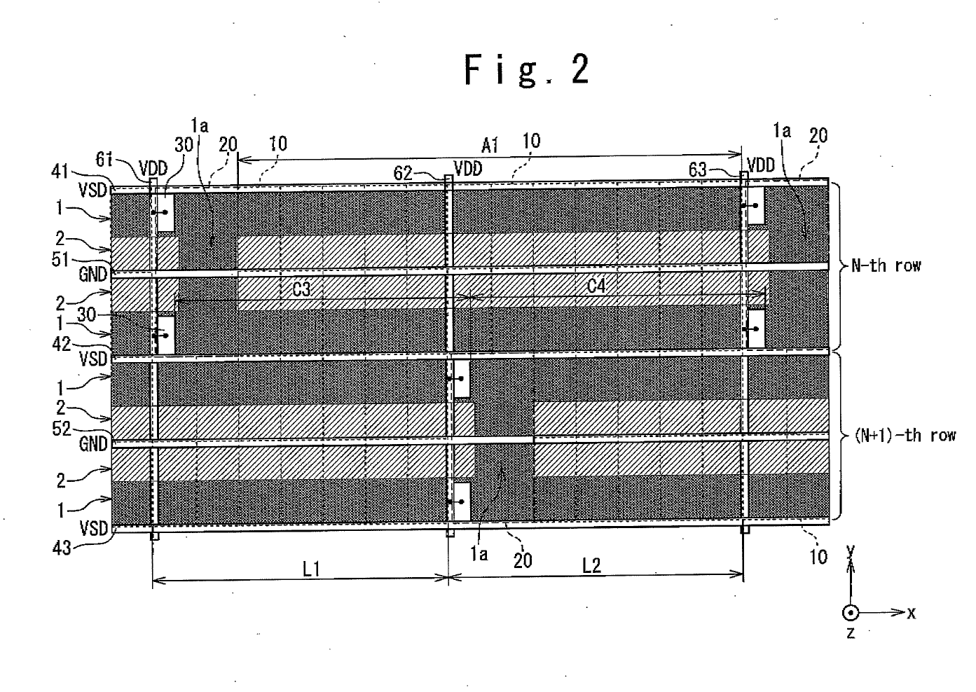

A description is given of a semiconductor device in a first embodiment according to the present invention, referring to FIGS. 1 to 9. FIG. 2 is a plan view showing an exemplary layout of the semiconductor device of the first embodiment of the present invention. Referring to FIG. 2, the semiconductor device of this embodiment is provided with: power supply lines 41 to 43 extended in the row direction (or the X axis direction); ground lines 51 and 52 extended in the row direction; a plurality of cells 10 (for example, primitive cells or standard cells) disposed along the power supply lines 41 to 43, 51 and 52; power supply lines 61 to 63 extended in the Y-axis direction perpendicularly to the power supply lines 41 to 43; and a plurality of cells 20 (power supply cells) for supplying a power supply voltage VDD to the plurality of cells 10.

The cells 20 include power supply elements 30 supplying a power supply voltage corresponding to the power supply voltage VDD supplied from the power supply lines 61 to 63, to the cells 10. In one embodiment, the power supply elements 30 include well contacts supplying the power supply voltage VDD from the power supply lines 61 to 63 to the substrate of the cells 10 and 20 (or N wells 1). Alternatively, the power supply elements 30 may include power supply switches supplying the power supply voltage VSD corresponding to the power supply voltage VDD from the power supply lines 61 to 63 to the substrate of the cells 10 and 20 (or the N wells 1). The power supply switches control the operation of supplying the power supply voltage VSD to the cells 10 in response to a control signal (not shown). It should be noted that the power supply elements 30 may each include both of the well contacts and the power supply switches.

The cells 10 include logical circuits (not shown) operated on the power supply voltage VSD fed from the power supply lines 41 to 43 and the ground voltage GND fed from the ground lines 51 and 52, respectively.

In each cell 20, N wells 1 are formed in the upper and lower regions arrayed in the cell height direction (that is, in the Y-axis direction); that is, the N wells 1 are formed in the regions adjacent to the adjoining rows thereto. Hereinafter, the N well 1 formed in the upper region is referred to as “upper N well 1”, and the N well 1 formed in the lower region is referred to as “lower N well 1”. Further, the P wells 2 of each cell 20 are formed in the region between the upper and lower N wells 1. As described later, the upper N and lower N wells 1 of each cell 20 are adjoined to each other so as to separate the P wells 2 of each cell 20 from the P wells 2 of the cells 10 adjacent on the right to the cell 20 in the row direction. Such structure of the N well 1 of each cell 20 is referred to as “bridge structure”; the portions of the upper N and lower N wells 1 which are positioned between the P wells 2 of each cell 20 and the P well 2 of the cell 10 adjacent on the right to the cell 20 separated adjacent in the row direction are referred to as bridge portions 1a. The bridge structure in each cell 20 is composed of well portions adjacent to N-wells 1 of the adjacent the cells 10 and the bridge portion 1a disposed therebetween. Each of the upper and lower N wells 1 is provided with a power supply element 30.

In each cell 10, an N well 1 are formed in one of the upper and lower regions, which are defined as being arrayed in the cell height direction (in the Y-axis direction), and the P wells 2 are formed in the other region. Each cell 10 of a specific row is designed so that the N well 1 thereof is adjoined to the row adjacent to the specific row. In one embodiment, an array of cells 10 each having a cell height half that of the cells 20 are located between two cells 20 in the same row. In such arrangement, two cells 10 arrayed in the cell height direction (Y axis direction) in a specific row are adjoined to each other so that the N wells thereof 1 are adjoined to the boundaries of the two rows adjoined to the specific row and the two P wells 2 thereof are adjoined to each other within the specific row.

In such arrangement of the cells 10 and 20, an N well 1 in a certain cell 10 is adjoined to the N well 1 in the adjacent cell 10 or 20 in the same row. Similarly, a P well 2 in a certain cell 10 is connected to the P well 2 in the adjacent cell 10 or cell 20 in the same row. Thus, a series of N wells 1 are continuously formed and a series of P wells 2 are continuously formed. Further, the N wells 1 of a certain row are disposed at the boundaries between the certain row and the adjacent rows (for example, the boundary between the N−th and (N+1)−th rows, N being a natural number). Therefore, the N wells 1 are continuously formed between two adjacent rows (for example, between the N−th and (N+1)−th rows).

The power supply lines 41 to 43 and the ground lines 51 and 52 are arranged in the order of the power supply line 41, the ground line 51, the power supply line 42, the ground line 52 and the power supply line 43 from the top in the column direction (Y axis direction). The power supply voltage VSD is supplied to the power supply lines 41 to 43, and the ground voltage GND is supplied to the ground lines 51 and 52. The cells 10 and 20 are fed with the power supply voltage VSD from the closest ones of the power supply lines 41 to 43 via contacts provided within the cells 10 and 20, respectively. Further, the cells 10 and 20 are connected to ground through the closest ones of the power supply lines 51 and 52 via contacts (not shown) provided within the cells 10 and 20.

In this arrangement, vertically adjacent two cells 10 adjoined at the boundary of two adjacent rows are commonly connected to the same power supply line extending in the row direction. For example, the cells 10 in the N−th row and the cells 10 in the (N+1)−th row, which is adjacent to the N−th row, are connected to the same power supply line 42.

In this embodiment, the upper and lower N wells 1 in each cell 20 are respectively provided with power supply elements 30. Hereinafter, the power supply element 30 provided in the upper N well 1 is referred to as “upper power supply element 30”, and the power supply element 30 provided in the lower N well 1 is referred to as “lower power supply element 30”.

In a case where the power supply elements 30 are well contacts used for supplying the power supply voltage VDD to the N wells 1, for example, the power supply voltage VDD is supplied not only to the lower N wells 1 in the N−th row but also to the upper N wells 1. in the (N+1)−th row via the lower power supply elements 30 provided in the N−th row. Similarly, the power supply voltage VDD is supplied not only to the upper N wells 1 in the (N+1)−th row but also to the lower N wells 1 in the N−th row via the upper power supply element 30 provided in the (N+1)−th row. Accordingly, the power supply voltage VDD is supplied to the N wells 1 formed at the boundary between the N−th row and the (N+1)−th row by providing the cells 20 in any one of the N−th row and the (N+1)−th row, in this embodiment.

Alternatively, in a case where the power supply element 30 is a power supply switch used for supplying the power supply voltage VSD to the power supply lines 41 to 43, the power supply voltage VSD is supplied to the power supply line 42 positioned at the boundary between the N−th row and the (N+1)−th row by any kind of the switches (PMOS transistors 32) provided in the cells 20 positioned in the N−th (N+1)−th row.

As thus discussed, the present invention, by providing the cell 20 in any one of the N−th row and the (N+1)−th row, the power supply voltage can be supplied to the cells 10 in the vicinity of the boundary between the N−th row and the (N+1)−th row in this embodiment. In the example shown in FIG. 2, the cells 20 connected to the power supply lines 61 and 63 are provided only in the N−th row out of the N−th and (N+1)−th rows, and the cell 20 connected to the power supply line 62 is provided only in the (N+1)−th row. In this case, the cells which are provided in the (N+1)−th row and positioned adjacent to the cells 20 connected to the power supply lines 61 and 63 are connected to the power supply lines 61 and 63 via said cells 20, and the cells which are provided in the other rows and positioned adjacent to the cell 20 connected to the power supply line 62 are connected to the power supply line 62 via said cell 20. Accordingly, the semiconductor device layout of this embodiment eliminates a need of providing a cell 20 in the region adjacent to another cell 20. Herein, the power supply lines 61 to 63 are arranged in the order of the power supply lines 61, 62 and 63 from the left in the row direction (Y-axis direction). Thus, in the layout of the semiconductor device of this embodiment, the cells 20 are disposed in a staggered array over two adjacent rows (the N−th row and (N+1)−th row).

The two cells 20 provided in the N−th row supply the power supply voltage VSD, which corresponds to the power supply voltage VDD supplied from the power supply lines 61 and 63, to the cells 10. On the other hand, the cells 20 provided in the (N+1)−th row supply the power supply voltage VSD, which corresponds to the power supply voltage VDD supplied from the power supply line 62, to the cells 10. The cells 10 positioned between the power supply lines 61 and 63 in the N−th row are supplied with the power supply voltage VSD from the cell 20 provided in the (N+1)−th row. Therefore, the distances between the power supply elements 30 restricted due to the manufacture process and so forth are the distances C3 and C4 between the lower power supply elements 30 formed in the N−th row and the upper power supply element 30 formed in the (N+1)−th row. Herein, the distances C3 and C4 are approximately equal to the distances C1 and C2. That is, even if the layout structure is modified to that of this embodiment, the distances satisfying the restrictions can be ensured.

Thus, the semiconductor device of this embodiment allows disposing the cells 20, skipping one power supply line for the power supply lines 61 to 63 in the N−th row. That is, the cells 10 can be placed in the region between the cell 20 adjacent to the power supply line 61 and the cell 20 adjacent to the power supply line 63 (which are separated with the distance A1). The region available for the placement of the cells 10 is larger than that in the conventional art shown in FIG. 1, since there is provided no power supply cell adjacent to the power supply line 63 in the N−th row. More specifically, in a case where the distance between the power supply lines 61 and 63 is L1+L2, as is the case of the conventional semiconductor device shown in FIG. 1, the width of the region in which the cells 10 can be placed in the N−th row in this embodiment is the distance A1, which is obtained by subtracting the width of one cell 10 from the distance L1+L2. On the other hand, the width of the region in which the cells 10 can be placed in the N−th row in the conventional art shown in FIG. 1 is the sum of the distances B1 and B2, wherein B1 is obtained by subtracting the width of the cells 70 from L1 and B2 is obtained by subtracting the width of the cells 70 from L2. That is, the distance A1 is larger than the distance B1+B2 obtained by subtracting the width of the two cells 70 from L1+L2 (i.e., B1+B2<A1).

As described above, the semiconductor device of this embodiment effectively enlarges the region in which the cells can be disposed between the power supply cells 20, while maintaining the spaces between the power supply elements for satisfying the restrictions imposed by the manufacture processes. Thus, the semiconductor device of this embodiment effectively increases the number of the cells 10 which can be placed. Furthermore, the configuration of the semiconductor device of this embodiment allows placing variously-sized standard cells, thereby facilitating the improvement of the TAT (Turn Around Time) and area efficiency, since the region in which the cells can be placed is enlarged.

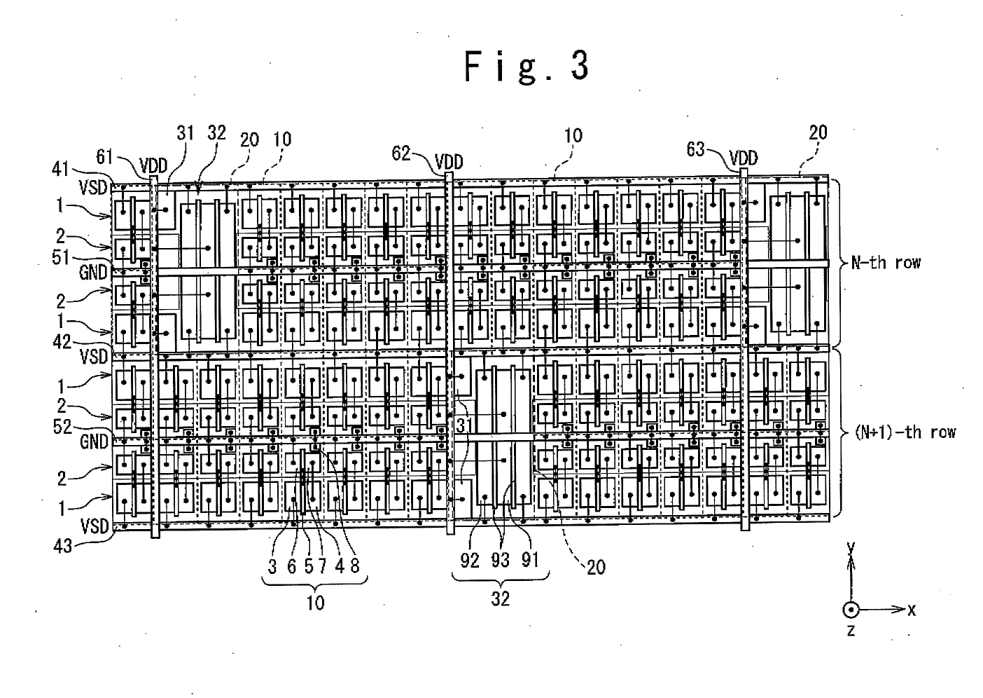

Next, a description is given of specific examples of the semiconductor device of the first embodiment, referring to FIGS. 3 to 9. In the following, described is a semiconductor device having functioning cells for which the power supply is controlled in response to switching between a normal mode and a standby mode. Herein, the normal mode means a state in which a normal operation goes on and the standby mode means a state in which at least some of the functioning cells are not operated.

The switching of the normal mode and the standby mode is achieved by using power supply switches. The power supply switches supply the power supply voltage VSD corresponding to the power supply voltage VDD to the standard cells. The standard cells are operated on the power supply voltage VSD. When power supply switches are used, it is necessary to supply a fixed voltage (i.e., power supply voltage VDD) to the N well of each of cells incorporating the power supply switches (which may be referred to as power supply switch cells, hereinafter). The power supply voltage supplied to the N wells of the standard cells operated on the power supply voltage VSD is selected from the power supply voltage VSD and the power supply voltage VDD, When the power supply voltage VSD is fed to the N wells of the standard cells, it is necessary to extend the distance between the power supply switch cells and the standard cells, since a potential difference is generated between the N wells of the power supply switch cells and the N wells of the standard cells. This undesirably increases the chip size. When the power supply voltage VDD is fed to the N wells of the standard cells, it is necessary to arrange well contacts at certain reduced intervals in order to avoid the latch up in the N-well. In this case, when the interval between cells including well contacts is reduced, the size and number of standard cells disposed between the cells including well contacts are restricted. In this embodiment, however, the power supply voltage VDD is fed to the N wells of the standard cells, since the area demerit is relatively serious.

### First Example

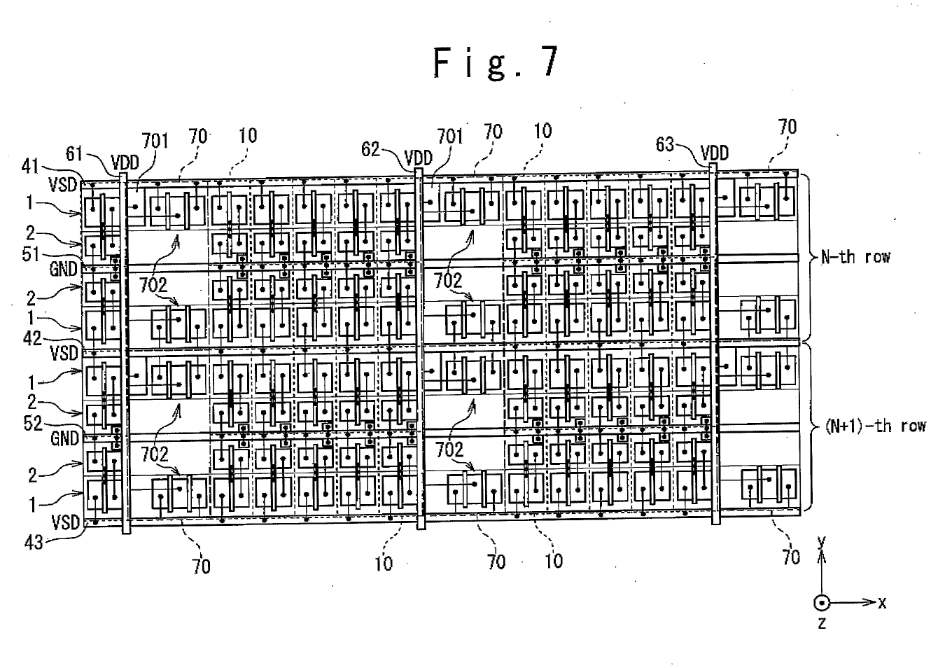

FIG. 3 is a plan view showing a first example of the layout of a semiconductor device of the first embodiment. In the first example, each cell 20 includes well contacts and power supply switches as mentioned above as the power supply elements 30. FIG. 7 is a plan view showing a comparative example corresponding to the semiconductor device shown in FIG. 3.

In the first example, the ratio of the intervals between the power supply switches to the intervals of the well contacts in the row direction is one to one. The structure of the semiconductor device of the example shown in FIG. 3 is generally similar to the layout shown in FIG. 2. Since the arrangement of the power supply lines 41 to 43, the ground lines 51, 52, the power supply lines 61 to 63 and the arrangement of the cells 10 and 20 (the distances between the lines and so forth) are similar to those shown in FIG. 2, a detailed description thereof is not given here.

Referring to FIG. 3, each cell 10 includes a PMOS transistor 11 provided for the N well 1 and an NMOS transistor 12 provided for the P well 2. The PMOS transistor 11 includes P-type diffusion layers 3 and 4 provided within the N well 1 and a gate electrode 5. The NMOS transistor 12 includes N-type diffusion layers 6 and 7 provided on the P well 2 and a gate electrode 9.

The cells 10 are arranged in two sub-rows: upper and lower sub-rows arrayed in the cell height direction (Y-axis direction) in each row. In the following, a description is given of the structure of the cells 10 disposed in the upper sub-row in the N−th row. In the PMOS transistors 11 of the cells 10 disposed in the upper sub-row, the P-type diffusion layers 3 are used as the sources electrically connected to the power supply line 41 and the P-type diffusion layers 4 are used as the drains connected to the corresponding N-type diffusion layers 7. In the NMOS transistors 12, on the other hand, the N-type diffusion layers 6 are used as the sources connected to the ground line 51 and the N-type diffusion layers 7 are used as the drains electrically connected to the corresponding P-type diffusion layer 4. In such arrangement, an inverter operated on the power supply voltage VSD is formed in each cell 10. Similarly, the cells 10 disposed in the lower sub-row in the N−th row each constitute an inverter incorporating a PMOS transistor 11 having a source connected to the power supply line 42 and an NMOS transistor 12 having a source connected to the ground line 51.

The cells 20 each include two N-type diffusion layers 31 functioning as well contacts and two PMOS transistors 32 functioning as power supply switches. The N wells 1 are formed in the upper and lower regions arrayed in the cell height direction (Y-axis direction) in each cell 20. Hereinafter, the N well 1 disposed in the upper region of each cell 20 is referred to as “upper N well 1”, and the N well 1 disposed in the lower region of each cell 20 is referred to as “lower N well 1”. The P wells 2 are formed in the region between the upper and lower N wells 1, the region being adjacent to other cells 10 in the cell width direction (X axis direction). Further, the upper and lower N wells 1 are adjoined so as to separate the P wells 2 of each cell 20 from the P-wells of the cells 10 adjacent on the right to the each cell 20 to form a bridge structure.

Two N-type diffusion layers 31 are disposed in the upper and lower N wells 1, respectively. The two N type diffusion layers 31 are connected to the power supply line 61 via upper interconnections (not shown) so as to supply the power supply voltage VDD to the corresponding N wells 1. Hereinafter, the N-type diffusion layer 31 disposed in the upper N well 1 in each cell 20 is referred to as “upper N type diffusion layer 31”, and the N type diffusion layer 31 disposed in the lower N well 1 is referred to as “lower N type diffusion layer 31”.

As described above, the N wells 1 and the P wells 2 are continuously formed in the row direction (X-axis direction), and the N wells 1 are continuously formed in the column direction (Y-axis direction) across each boundary between adjacent two rows. Further, the cells 20 are each provided with two N-type diffusion layers 31 functioning as well contacts in the upper and lower sub-rows, respectively. Thus, the power supply voltage VDD is supplied not only to the lower N well 1 in the N−th row but also to the upper N well 1 in the (N+1)−th row via the lower N type diffusion layer 31 provided in the N−th row. Similarly, the power supply voltage VDD is supplied not only the upper N well 1 in the (N+1)−th row but also to the lower N well 1 in the N−th row via the upper N type diffusion layer 31 provided in the (N+1)−th row. Therefore, the power supply voltage VDD is supplied to the N wells 1 disposed at the boundary between the N−th row and the (N+1)−th row in this embodiment, by providing a cell 20 in only one of the N−th row and the (N+1)−th row for each power supply line. For example, a cell 20 connected to each of the power supply lines 61 to 63 is disposed only in one of the N−th row and the (N+1)−th row.

Next, the structure of the PMOS transistors 32 is described in details. Herein, the PMOS transistors 32 connected to the power supply line 61 in the N−th row are explained as an example. The PMOS transistors 32 each include P-type diffusion layers 91 and 92 and a gate electrode 93 provided for the N well 1, which has a bridge structure. The P-type diffusion layer 91, which functions as a source, is connected to the power supply line 61 through which the power supply voltage VDD is supplied. The P type diffusion layer 92, which functions as a drain, is connected to the power supply lines 41 and 42. The PMOS transistors 32 feeds the power supply voltage VSD corresponding to the power supply voltage VDD to the power supply lines 41 and 42 in response to a control signal (not shown) applied to the gate electrode 93.

Two cells 10 adjoined to each other at the boundary of adjacent two rows are connected to the same power supply line extending in the row direction. For example, a cell 10 in the N−th row adjacent to the (N+1)−th row and a cell 10 in the (N+1)−th row adjacent to the N−th row are both connected to the same power supply line 42. The power supply voltage VSD is supplied to the power supply line 42 via either a power supply switch (PMOS transistor 32) in the cell 20 disposed in the N−th row or a power supply switch (MOS transistor 32) in the cell 20 disposed in the (N+1)−th row. That is, in this embodiment, the power supply voltage VSD is supplied to the cells 10 disposed at the boundary between the N−th row and the (N+1)−th row by providing a cell 20 in any one of the N−th row and the (N+1)−th row. For example, cells 20 respectively connected to the power supply lines 61 to 63 may be disposed only in any one of the N−th row and the (N+1)−th row.

On the basis of the above-described discussion, the cells 20 are disposed in a staggered array over the N−th row and (N+1)−th row in this embodiment, so that the distance between the lower N-type diffusion layer 31 in the cell 20 disposed in the N−th row and the upper N-type diffusion layer 31 in the cell 20 disposed in the (N+1)−th row is shorter than the intervals between well contacts required for ensuring a latch-up resistance. In the example shown in FIG. 3, the cells 20 connected to the power supply lines 61 and 63 are disposed only in the N−th row of the adjacent two rows (N−th row and (N+1)−th row), and the cell 20 connected to the power supply line 62 is disposed only in the (N+1)−th row.

In the comparative example shown in FIG. 7, on the other hand, an N-type diffusion layer 701 functioning as a well contact is provided only in the upper row of each cell 70. In this case, the lower N well 1 in the N−th row is supplied with the power supply voltage VDD from the cell 70 disposed in the (N+1)−th row. That is, in order to supply the power supply voltage VDD fed to the N wells 1 with intervals of well contacts required for ensuring a latch-up resistance, it is necessary to dispose the cells 70 in the N−th row and (N+1)−th row at those intervals.

The example shown in FIG. 3 allows increasing the intervals between the cells 20 arranged in the N−th row, for example, compared to those in the comparative example shown in FIG. 7, since the cells 20 can be disposed in the staggered manner. Thus, the number of the cells 10 which can be placed can be increased compared to the comparative example. Further, variously-sized standard cells can be disposed and therefore the design of the semiconductor device can be facilitated to thereby improve the TAT (Turn Around Time) and area efficiency, since the region in which cells can be placed is enlarged.

Furthermore, the latch-up resistance can be increased in this embodiment due to the bridge structure which provides an electrical connection between the upper N well 1 and the lower N well 1 within each cell 20, while the N wells 1 separately disposed in the upper and lower regions of the cell 70 are each provided with the PMOS transistors 702 functioning as the power supply switches in the comparative example shown in FIG. 7.

### Second Example

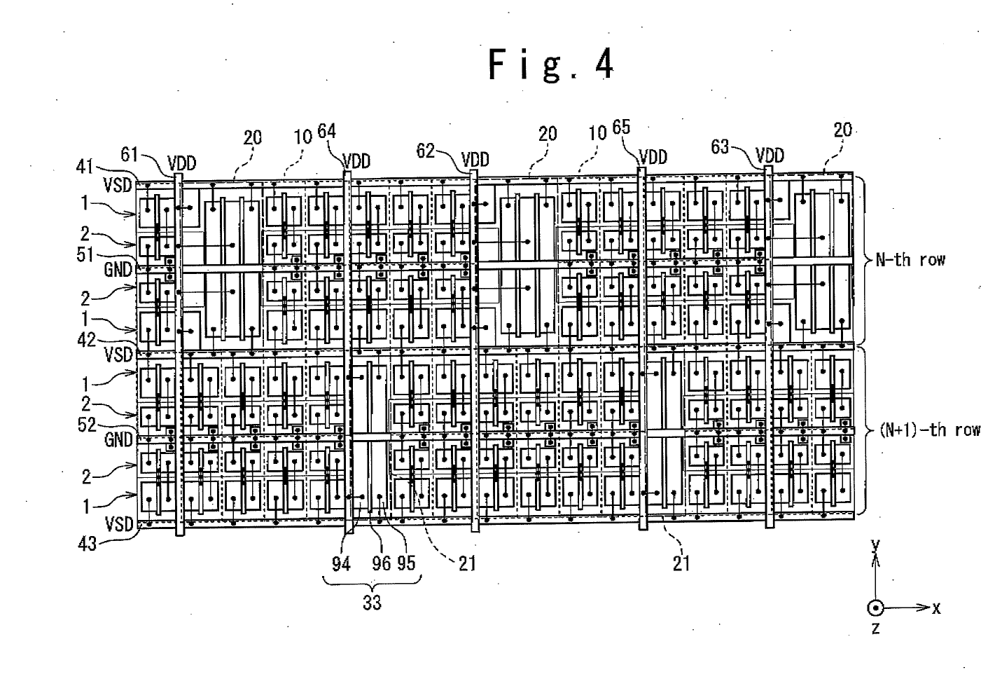

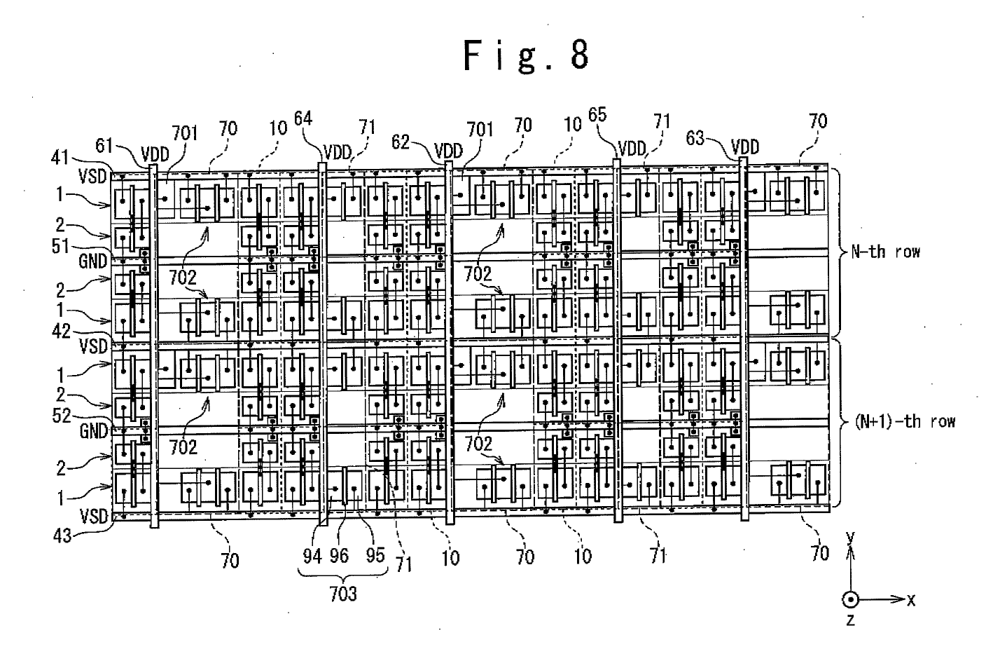

FIG, 4 is a plan view showing another example (the second example) of the layout of the semiconductor device of the first embodiment. The cells 20 in the second example has the same structure as that of the first example. FIG. 8 is a plan view showing a comparative example to be compared to the semiconductor device of the second example shown in FIG. 4.

The ratio of the intervals of the power supply switches to the intervals of the well contacts in the row direction in the second example is 0.5:1, while that in the first example is 1:1. That is, the power source strength is doubled in the semiconductor device of the second example compared to the first example. In the following, a description of components of the second example similar to those of the first example is not given here, and only components different from those of the first example are described below.

Referring to FIG. 4, the intervals between the power supply lines 61 and 62 and between the power supply lines 62 and 63 are the same as the first example. An additional power supply line 64 is provided between the power supply lines 61 and 62 and an additional power supply line 65 is provided between the power supply lines 62 and 63. Cells 20 are disposed in the N−th row and connected to the power supply lines 61 to 63. On the other hand, cells 21 are disposed in the (N+1)−th row and connected to the power supply lines 64 and 65. The cells 10 are disposed in the regions other than the regions in which the cells 20 and 21 are disposed.

The structure of the cells 20 is similar to that of the first example. That is, the cells 20 each include the N type diffusion layers 31 functioning as the well contacts in the upper and lower regions. Therefore, the cells 20 are disposed only in one of the adjacent two rows, while the well contacts are spaced in the same manner as that of the comparative example shown in FIG. 8.

The cells 21 have a cell height same as that of the cells 20 and has a cell width narrower than that of the cells 20. The cells 21 each include a PMOS transistor 33 which functions as a power supply switch. Hereinafter, the structure of the PMOS transistor 33 connected to the power supply line 64 is described in detail as an example. The PMOS transistor 33 includes P-type diffusion layers 94 and 95 and a gate electrode 96 provided for the N well 1. The P-type diffusion layer 94, which functions as a source, is connected to the power supply line 64 through which the power supply voltage VDD is supplied. The P-type diffusion layer 95, which functions as a drain, is connected to the power supply lines 42 and 43. The PMOS transistor 33 supplies the power supply voltage VSD corresponding to the power supply voltage VDD to the power supply lines 42 and 43 in response to a control signal (not shown) applied to the gate electrode 96.

The cells 20, each having a well contact and a power supply switch, are disposed along the power supply lines 61 to 63, and the cells 21, each having only a power supply switch, are disposed along the additional power supply lines 64 and 65, whereby the power supply switches are spaced by half of the distance between the well contacts. Further, the cells 21 control the supply of the power supply voltage VSD to the power supply lines adjacent thereto in the cell height direction (Y-axis direction). For example, the cell 21 connected to the power supply line 64 is disposed in only one of the N−th row and (N+1)−th row. Therefore, the cells 20 and 21 can be arranged in the staggered manner in the N−th and (N+1)−th rows as shown in FIG. 4 in this example.

In the comparative example shown in FIG. 8, on the other hand, an N-type diffusion layer 701, which functions as a well contact, is provided only in the upper sub-row of each cell 70. In this case, it is necessary to supply the power supply voltage VDD to the lower N wells 1 in the N−th row by the cell 70 disposed in the (N+1)−th row. Therefore, in order to supply the power supply voltage VDD fed to the N wells 1 with intervals of well contacts required for ensuring a latch-up resistance, it is necessary to dispose the cells 70 in the N−th row and (N+1)−th row at those intervals.

Further, in the comparative example shown in FIG. 8, the cells 71 each having only a PMOS transistor 703 functioning as a power supply switch are continuously disposed in the column direction (Y-axis direction). For example, the cells 71 connected to the power supply line 64 are disposed in both of the adjacent N−th and (N+1)−th rows.

In contrast, the intervals of the cells 20 disposed in the N−th row and the intervals of the cells 21 disposed in the (N+1)−th row can be increased in this example compared to those of the comparative example, since the cells 20 and 21 are disposed in the staggered manner. Thus, the number of the cells 10 which can be placed is increased compared to the comparative example shown in FIG. 8. Furthermore, variously-sized standard cells can be disposed and therefore the designing of the semiconductor device can be facilitated to thereby improve the TAT (Turn Around Time) and area efficiency, since the region in which cells can be placed is enlarged.

### Third Example

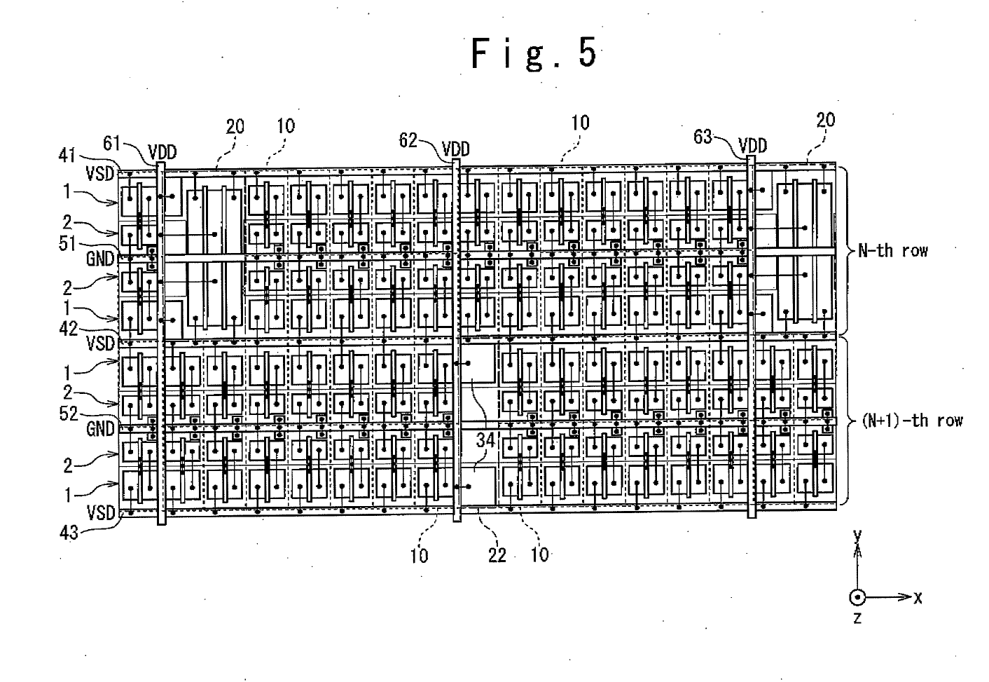

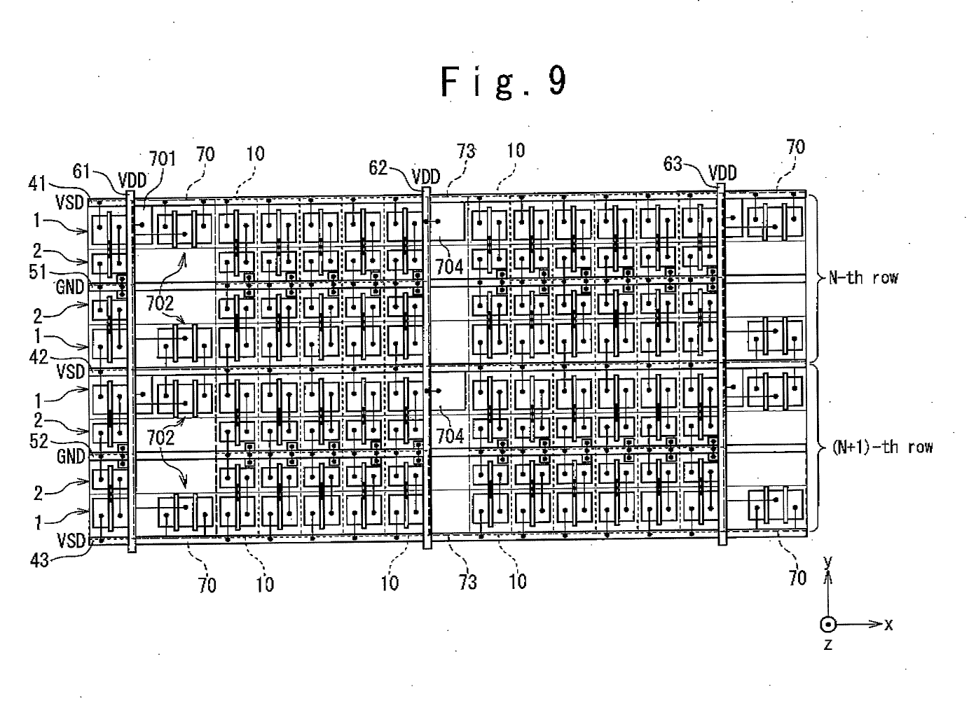

FIG. 5 is a plan view showing still another example (the third example) of the layout of the semiconductor device of the first embodiment. In the third example, the cells 20 have the same structure as that of the first example. FIG. 9 is a plan view showing a comparative example to be compared to the semiconductor device of the third example shown in FIG. 5.

The ratio of the intervals of the power supply switches to the space of the well contacts in the row direction in the third example is 2.1:1, while that of the first example is 1:1. That is, the power source strength is reduced by one-half in the semiconductor device of the third example, compared to the first example. In the following, a description of components similar to those of the first example is omitted here, and only components different from those of the first example are explained below.

Referring to FIG. 5, the cells 20 disposed in the N−th row are connected to the power supply lines 61 and 63, and the cell 22 disposed in the (N+1)−th row is connected to the power supply line 63. The cells 10 are disposed in the regions other than the regions in which the cells 20 and 22 are disposed.

The structure of the cells 20 is similar to that of the first example. That is, the cells 20 each include N-type diffusion layers 31 functioning as well contacts in the upper and lower regions. Therefore, the cells 20 are disposed only in one of the adjacent two rows while the well contacts are positioned at the same intervals as those of the comparative example shown in FIG. 9.

The cell 22 has the same cell height as that of the cells 20 and has a cell width narrower than that of the cells 20. The cell 22 includes two N-type diffusion layers 34 functioning as well contacts. Specifically, the cell 22 includes N wells 1 in the upper and lower regions in the cell height direction (Y axis direction), respectively, and includes P wells 2 between the N wells 1. The two N-type diffusion layers 34 are provided in the upper and lower wells 1 and connected to the power supply line 62, respectively.

The cells 20, each incorporating a power supply switch, are disposed along the power supply lines 61 and 63, and the cell 22, which incorporates only well contacts, is disposed along the power supply line 62, whereby the power supply switches are spaced by a distance of almost twice of that of the well contacts. Further, the cell 22, similarly to the cells 20, includes the N-type diffusion layers 34 functioning as the well contacts in the upper and lower regions in the cell height direction (Y-axis direction). Thus, the cell 22 is disposed in only one of the N−th row and (N+1)−th row. Therefore, the cells 20 and 22 are arranged in the staggered manner in the N−th and (N+1)−th rows in the example shown in FIG. 5.

On the other hand, in the comparative example shown in FIG. 9, the N type diffusion layers 701 and 704, which function as well contacts, are provided only in the upper sub-rows of the cells 70 and 73, respectively. In this case, it is necessary that the lower N wells 1 in the N−th row is supplied with the power supply voltage VDD by the cell 70 or 73 disposed in the (N+1)−th row. Therefore, in order to supply the power supply voltage VDD to the N wells 1 with intervals of the well contacts required for ensuring a latch-up resistance, it is necessary to dispose the cells 70 in the N−th row and (N+1)−th row at those intervals.

In contrast, the intervals of the cells 20 disposed in the N−th row and the intervals of the cells 22 disposed in the (N+1)−th row can be increased in this example, compared to the comparative example, since the cells 20 and 22 can be disposed in the staggered manner. Thus, the number of the cells 10 which can be placed is increased compared to the comparative example shown in FIG. 9. Further, variously-sized standard cells can be disposed and therefore the design of the semiconductor device can be facilitated to thereby improve the TAT (Turn Around Time) and area efficiency, since the region in which cells can be placed is enlarged.

### Fourth Example

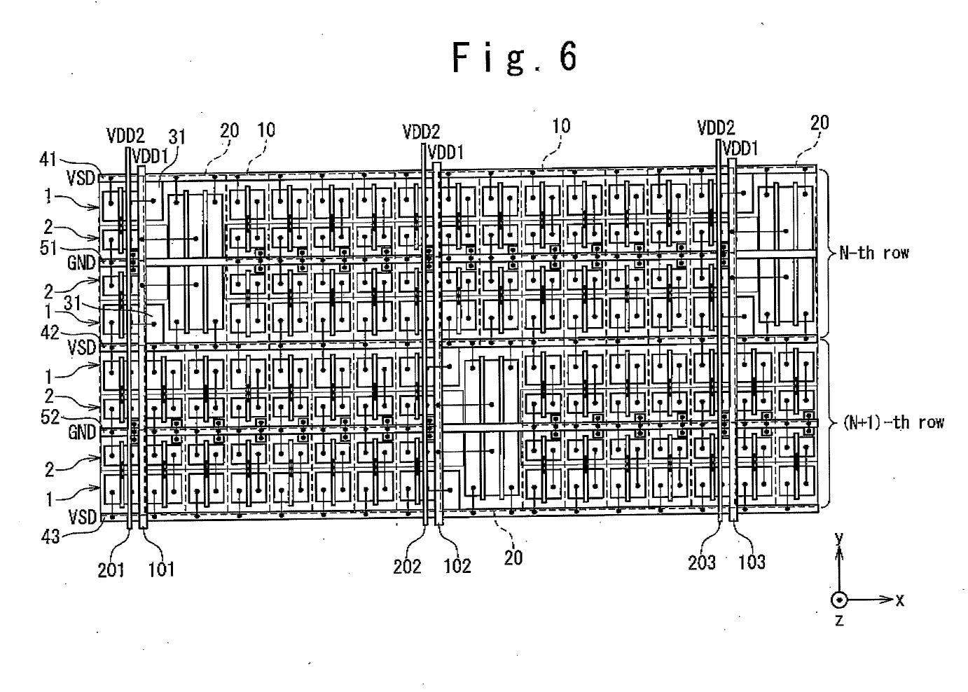

FIG. 6 is a plan view showing still another example (fourth example) of a layout structure of the semiconductor device according to the first embodiment. In the fourth example, the cells 20 have the same structure as those of the first example.

In the first to third examples, the power source potential VDD is commonly supplied as the substrate bias and the source bias of the power supply switch cells 20. In contrast, in the fourth example, a fixed bias (power supply voltage VDD2) different from the source bias (power supply voltage VDD1) is supplied as the substrate bias. The other configurations are similar to those of the first example.

The semiconductor device in the fourth example is provided with power supply lines 101 and 201 instead of the power supply line 61 in the first example. Similarly, the semiconductor device is provided with power supply lines 102 and 202 instead of the power supply line 62, and provided with power supply lines 103 and 203 instead of the power supply line 63. The power supply lines 101 and 103 are supplied with the power supply voltage VDD1 and are connected to the sources of the PMOS transistors 32 in the cells 20. The PMOS transistors 32 supply the power supply voltage VSD corresponding to the power supply voltage VDD1 to the cells 10. The power supply lines 201 to 203 are supplied with the power supply voltage VDD2 and are connected to the N-type diffusion layers 31 in the cells 20. The potential of the N-wells 1 are fixed to the power supply voltage VDD2, which is supplied via the N-type diffusion layers 31.

Similarly to the first example, the intervals of the cells 20 disposed in the N−th row and the intervals of the cells 22 disposed in the (N+1)−th row can be increased in this example, compared to those of the comparative example, since the cells 20 are disposed in a staggered manner. Thus, the number of the cells 10 which can be placed is increased compared to the comparative example shown in FIG. 7. Further, variously-sized standard cells can be disposed and therefore the designing of the semiconductor device can be facilitated to thereby improve the TAT (Turn Around Time) and area efficiency, since the region in which cells can be placed is enlarged.

### 2. Second Embodiment

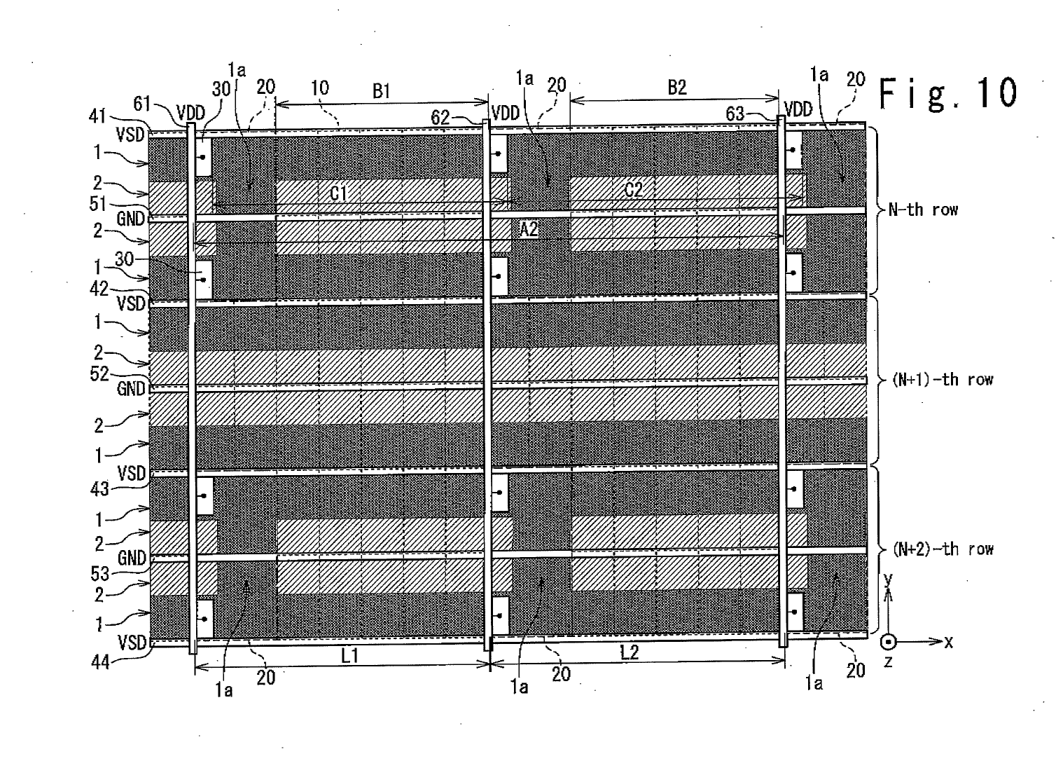

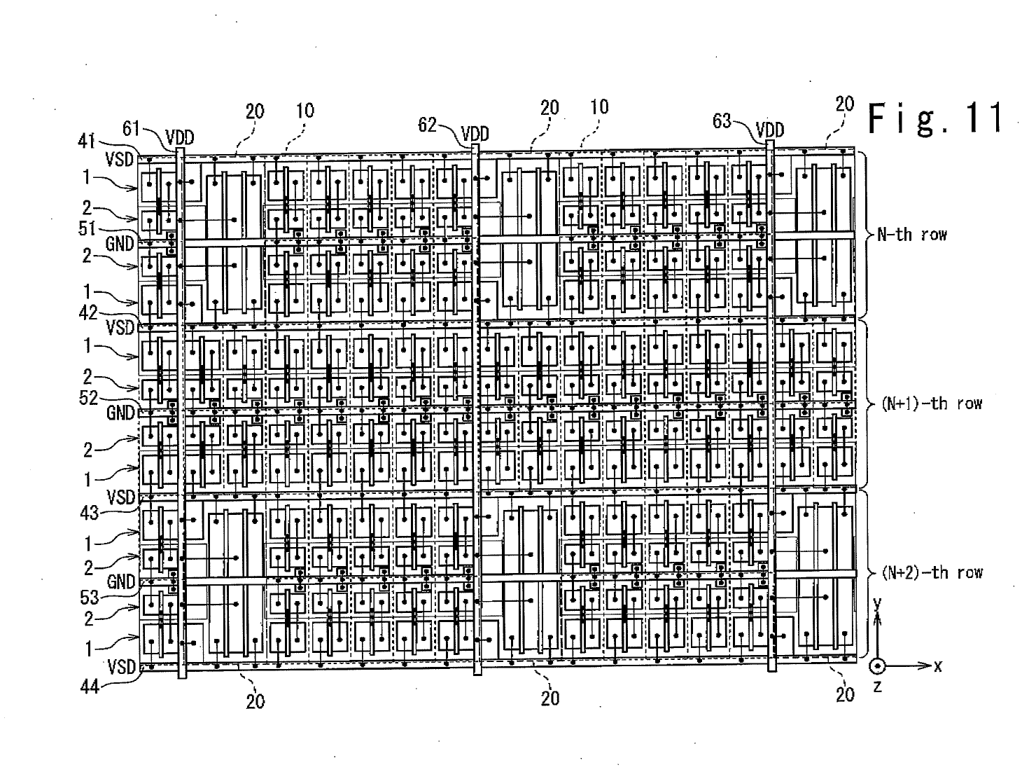

In the following, a description is given of a semiconductor device of a second embodiment according to the present invention referring to FIGS. 10 and 11. FIG. 10 is a plan view showing an exemplary layout of the semiconductor device of the second embodiment. In the first embodiment, the cells 20 are arranged in a staggered manner over the N−th row and the (N+1)−th row, whereas rows in which the cells 20 are placed (for example, the N−th and (N+2)+th rows, N being a natural number) and rows in which the cells 20 are not placed (for example, the (N+1)−th row) are alternately arranged in the second embodiment. That is, the cells 20 are disposed every two rows.

Referring to FIG. 10, the semiconductor device of this embodiment includes power supply lines 41 to 44 extended in the row direction (X-axis direction); ground lines 51 to 53 extended in the row direction; a plurality of cells 10 (for example, primitive cells or standard cells) disposed along the power supply lines 41 to 44 and the ground lines 51 to 53; power supply lines 61 to 63 extended in the direction perpendicular to the power supply lines 41 to 43 and ground lines 51 to 53 (Y-axis direction); and a plurality of cells 20 for supplying a power supply voltage VDD to the cells 10.

The cells 10 and 20 have configurations similar to those of the first embodiment. A cell 20 of a specific row supplies the power supply voltage to the N wells 1 of the rows adjacent to the specific row in the column direction (Y-axis direction), since the power supply elements 30 are disposed in both of the upper and lower regions of the cell 20. Specifically, the power supply voltage is supplied to the N wells 1 formed in the (N+1)−th row via the cells 20 disposed in the N−th and (N+2)+th rows.

The three cells 20 provided in the N−th row supply the power supply voltage VSD corresponding to the power supply voltage VDD supplied from the power supply lines 61 to 63, respectively, to the cells 10. Similarly, the three cells 20 provided in the (N+2)+th row supply the power supply voltage VSD corresponding to the power supply voltage VDD supplied from the power supply lines 61 to 63, to the cells 10. The cells 10 provided in the (N+1)−th row are supplied with the power supply voltage VSD from the cells 20 provided in the N−th and (N+2)+th rows. Therefore, the distances between the power supply elements 30 to be restricted depending on the manufacture process are the distances C1 and C2 between the power supply elements 30 formed in the two cells 20 in the N−th and (N+2)+th rows. The cells 20 are disposed so that the distances C1 and C2 are adjusted to provide the latch-up resistance.

In the semiconductor device of this embodiment, the width of the region in which the cells 10 can be placed is restricted below a certain distance depending on the manufacture process in the N−th and (N+2)+th rows in which the cells 20 are disposed, whereas the region in which the cells 10 can be placed is extended to a large range, which is represented by the distance A2 in FIG. 10. More specifically, in a case where the distance between the power supply lines 61 and 63 is L1+L2 as is the case of the conventional semiconductor shown in FIG. 1, the width of the region in which the cells 10 can be disposed in the N−th row is a distance C3 calculated by subtracting the width of one cell 10 from the distance L1+L2. On the other hand, the width of the region in which the cells 10 can be placed in the (N+1)−th row shown in FIG. 10 is a sum of the distances L1 and L2, i.e., A2=L1+L2. That is, the cells 10 can be disposed in the entire region of the (N+1)−th row.

As described above, the semiconductor device of this embodiment effectively enlarges the region in which the cells 10 can be disposed between the power supply cells 20, while the intervals between the power supply elements are maintained for satisfying the restrictions imposed by the manufacture processes. Thus, the number of the cells 10 which can be placed is effectively increased in this embodiment. Further, variously-sized standard cells can be disposed, and therefore the design of the semiconductor device can be facilitated to thereby improve the TAT (Turn Around Time) and area efficiency, since the region in which cells can be placed is enlarged.

In the following, a description is given of a specific example of the semiconductor device of the second embodiment referring to FIG. 11. Shown in FIG. 11 is a semiconductor device having functioning cells for which the supply of the power supply voltage is controlled in response to switching between a normal mode and a standby mode similarly to the first to fourth examples of the first embodiment.

### Fifth Example

FIG. 11 is a plan view showing an example (the fifth example) of the layout of the semiconductor device of the second embodiment. In the fifth example, the cells 20 have the same structure as that of the first example of the first embodiment.

In the fifth example, the ratio of the intervals of the power supply switches to the intervals of the well contacts in the row direction is 1:1. Further, the structure of the semiconductor device in the this example shown in FIG. 11 is basically identical to the layout shown in FIG. 10. For example, the arrangement of the power supply lines 41 to 43, the ground lines 51 to 53, the power supply lines 61 to 63 and the cells 10 and 20 (i.e., distances between the wirings etc.) are same. That is, the cells 20 disposed in the N−th and (N+1)−th rows are connected to the power supply lines 61 to 63.

The upper N wells located in the (N+1)−th row is supplied with the power supply voltage VDD via the N-type diffusion layers 31 disposed in the N−th row, and the lower N wells 1 located in the (N+1)−th row is supplied with the power supply voltage VDD via the N-type diffusion layers 31 disposed in the (N+2)−th row. Further, the power supply line 42 disposed at the boundary between the N−th row and the (N+1)−th row is supplied with the power supply voltage VSD via the PMOS transistors 32 in the cells 20 disposed in the N−th row, and the power supply line 43 disposed at the boundary between the (N+1)−th row and the (N+2)+th row is supplied with the power supply voltage VSD via the PMOS transistors 32 in the cells 20 disposed in the (N+2)+th row.

In this example, the cells 10 can be arranged in the (N+1)−th row with improved flexibility, since there is no need to provide a cell 20 in the (N+1)−th row located between the N−th row and the (N+2)+th row, wherein cells 20 are arranged in the N−th and (N+2)+th rows. Thus, the number of the cells 10 which can be placed is effectively increased compared to the conventional semiconductor device having the power supply switches as shown in FIG. 1. Further, variously-sized standard cells can be disposed, and therefore the design of the semiconductor device can be facilitated to thereby improve the TAT (Turn Around Time) and area efficiency, since the region in which cells can be place is enlarged.

In summary, the present invention offers a semiconductor device layout which effectively improves the number of the cells 10 which can be placed to be disposed and the flexibility of the placement of the cells 10, in designing a semiconductor device having power supply switches controlling the supply of the power supply voltage to suppress a leakage current. It should be noted that the layout design of the semiconductor device mentioned above may be implemented by executing a layout program using a computer.

Although specific embodiments of the present invention are described above, it is apparent that the present invention is not limited to the above embodiments, but may be modified and changed without departing from the scope of the invention. For example, although only the layouts of the N−th to (N+1)−th rows and N−th to (N+2)+th rows are shown in the first and second embodiments, respectively, it would be understood that the actual layout may be repetition of the patterns shown in the drawings in the column direction. Further, it should be noted that the first to fifth examples may be adapted with combining within the scope arising no technical contradiction.

Further, although the description is referred to the cells 20 that controls the supply of the power supply voltage VSD corresponding to the power supply voltage VDD in the examples of the present embodiments, it may be adapted to the cells which control the supply of the ground voltage. In this case, it can be realized by replacing the N wells 1, the N type diffusion layers 31 and the PMOS transistors 32 with P wells, P-type diffusion layers and NMOS transistors, respectively.

What is claimed is:

1. A semiconductor device, comprising:
a first power supply cell;
a plurality of first cells; and
a plurality of second cells,
wherein said first power supply cell and said plurality of first cells are continuously arrayed in a row direction in a first row,
wherein said plurality of second cells are continuously arrayed in the row direction in a second row adjacent to said first row,
wherein said first power supply cell is connected to a first power supply line extending perpendicularly to said row direction to feed a power supply voltage corresponding to a voltage fed from said first power supply line to said plurality of first and second cells, and
wherein one of said plurality of second cells is indirectly connected to said first power supply line through said first power supply cell, said one of said plurality of second cells being positioned adjacent to said first power supply cell.

2. The semiconductor device according to claim 1, wherein said second cell adjacent to said first power supply cell is a primitive cell.

3. The semiconductor device according to claim 1, wherein said second cell adjacent to said first power supply cell is a standard cell.

4. The semiconductor device according to claim 1, wherein said plurality of first and second cells have first wells adjoined to each other, and
wherein said first power supply cell includes diffusion layers which provide electrical connections between said first power supply line and said first wells.

5. The semiconductor device according to claim 4, wherein said first power supply cell has second wells adjacent to said first wells, said second wells are respectively positioned in upper and lower regions arrayed in a cell height direction of said first power supply cell, and
wherein said diffusion layers are provided within said second wells.

6. The semiconductor device according to claim 1, further comprising a second power supply line perpendicular to said first power supply line,
wherein said first power supply cell includes a power supply switch feeding a power supply voltage corresponding to a voltage fed from said first power supply line to said plurality of first and second cells through said second power supply line, and
wherein said power supply switch controls supply of said power supply voltage in response to a control signal.

7. The semiconductor device according to claim 5, further comprising a second power supply line perpendicular to said first power supply line,
wherein said first power supply cell includes a power supply switch feeding a power supply voltage corresponding to a voltage fed from said first power supply line to said plurality of first and second cells through said second power supply line, and
wherein, in said first power supply cell, said second wells provided in said upper and lower regions constitute a bridge structure which includes first and second well portions positioned adjacent to top and bottom boundaries of said first power supply cells, respectively, and a bridge portion disposed between said first and second well portions,
wherein said power supply switch is provided for said bridge structure.

8. The semiconductor device according to claim 1, wherein a second power supply cell is arranged in said second row,
wherein said second power supply cell is connected to a third power supply line disposed in parallel to said first power supply line and supplies a power supply voltage corresponding to a voltage fed from said third power supply line to said plurality of first and second cells,
wherein one of said plurality of first cells arrayed in said second row is indirectly connected to said third power supply line through said second power supply cell, said one of said plurality of first cells being positioned adjacent to said second power supply cell arranged in said first row.

9. The semiconductor device according to claim 1, further comprising:
a third power supply cell;
a plurality of third cells; and
a plurality of fourth cells,
wherein said third power supply cell and said plurality of third cells are continuously arrayed in the row direction in a third row adjacent to said second row,
wherein said plurality of fourth cells are continuously arrayed in the row direction in said second row,
wherein said third power supply cell is connected to said first power supply line to feed the power supply voltage corresponding to the voltage fed from said first power supply line to said plurality of fourth and third cells, and
wherein one of said plurality of fourth cells are indirectly connected to said first power supply line through said third power supply cell, said one of plurality of fourth cells being positioned adjacent to said third power supply cell.

10. The semiconductor device according to claim 9, wherein said plurality of third and fourth cells have third wells adjoined to each other, and
wherein said third power supply cell includes diffusion layers which provide electrical connections between said first power supply line and said third wells.
